(19) United States
(12) Patent Application Publication
(10) Pub. No.: US 2009/0256471 A1
(43) Pub. Date: Oct. 15, 2009

(54) ORGANIC LIGHT EMITTING DIODE MODULE

(75) Inventors: Mun-Su Kim, Yongin-City (KR); Seung-Won Chegal, Yongin-City (KR); Jae-Sik Moon, Yongin-City (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG MOBIL DISPLAY CO., LTD., Yongin-City (KR)

(21) Appl. No.: 12/422,115

(22) Filed: Apr. 10, 2009

(30) Foreign Application Priority Data
Apr. 11, 2008 (KR) 10-2008-0033720

(51) Int. Cl. H01J 1/63

(52) U.S. Cl. 313/504

(57) ABSTRACT

An organic light emitting diode display module having packaging which protects one or more integrated circuits is disclosed. The packaging has first and second frames which enclose the display and connect to one another. The frames cover and protect the periphery of the light emitting device and the integrated circuits for the light emitting device.

### CROSS-REFERENCE TO RELATED APPLICATION

This application claims priority to and the benefit of Korean Patent Application No. 10-2008-0033720 filed in the Korean Intellectual Property Office on Apr. 11, 2008, the entire contents of which are incorporated herein by reference.

### BACKGROUND

1. Field

The field relates to an organic light emitting diode (OLED) module.

More particularly, the field relates to an OLED display module that is shock-resistant.

2. Description of the Related Art

A variety of display panels are used for display devices. These include OLED modules, which have been widely used because they have a quicker response speed and a better contrast ratio than other display panels.

A typical active matrix OLED display includes a plurality of pixels, which are basic elements for displaying an image and are arranged in a matrix pattern on a substrate.

A thin film transistor (TFT) is provided for each of the pixels to independently control the pixel.

In the OLED display, there is no need to mount a separate backlight unit. Therefore, thickness and weight of the OLED display can be reduced, and furthermore, electric power consumption can also be reduced.

Accordingly, use of OLED displays is on the rise because OLED displays are advantageous for mobile devices such as mobile phones, personal digital assistants (PDAs), portable multimedia players (PDPs), and the like.

Since the mobile devices are often used as the user moves, the mobile devices are easily exposed to shock.

Therefore, the OLED modules used for the mobile devices must be lightweight and shock-resistant.

In the typical OLED module, the OLED panel is designed to be protected by a frame. The frame, however, is designed to protect only the rear and side surfaces of the OLED panel.

That is, a front surface (i.e., a light emitting surface) of the OLED module is not protected by the frame and is thus vulnerable to external shock.

Furthermore, the frame is designed with an open structure having a surface that is fully open. Therefore, the frame is vulnerable to twisting or bending loads.

For example, when the frame is deformed by an external impact, the impact is directly transferred to the panel and thus the panel may be damaged.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is an organic light emitting diode module including an organic light emitting diode panel, which includes a light emitting region and a non-light emitting region. The module also has a first frame comprising an inner space for receiving the organic light emitting diode panel, and a second frame coupled to the first frame, where the second frame is configured to protect the non-light emitting region of the organic light emitting diode panel.

Another aspect is an organic light emitting diode display, including an organic light emitting diode panel which has a light emitting display and at least one integrated circuit, a first frame configured to receive the organic light emitting diode panel, and a second frame coupled to the first frame, where the second frame is configured to protect the integrated circuit.

### BRIEF DESCRIPTION OF THE DRAWINGS

FIG. 1 is a perspective view of an OLED module according to an exemplary embodiment.

FIG. 2 is a schematic exploded perspective view of the OLED module of FIG. 1.

FIG. 3 is a schematic front view of the OLED module of FIG. 1.

FIG. 4 is a cross-sectional view taken along line IV-IV of FIG. 3.

FIG. 5 is a view illustrating a variety of electronic devices to which the OLED display module of the present disclosure can be applied.

### DETAILED DESCRIPTION OF CERTAIN INVENTIVE EMBODIMENTS

Certain embodiments will be described with reference to the accompanying drawings, in which exemplary embodiments are shown.

As those skilled in the art would realize, the described embodiments may be modified in various different ways, without departing from the spirit or scope of the present disclosure.

Like reference numerals generally denote like elements throughout the drawings.

In the drawings, the thickness of layers, films, panels, regions, etc., may be exaggerated for clarity.

It will be understood that when an element such as a layer, film, region, or substrate is referred to as being “on” another element, it can be directly on the other element or intervening elements may also be present.

In contrast, when an element is referred to as being “directly on” another element, there are no intervening elements present.

Throughout this specification and the claims that follow, when it is described that an element is “coupled” to another element, this may include a case where the element is “directly coupled” to another element and/or a case where the element is “indirectly connected” to another element with another element interposed therebetween.

Further, when it is described that a structure “includes” a constituent element, it means that the structure may further include other constituent elements in addition to the element unless specifically referred to the contrary.

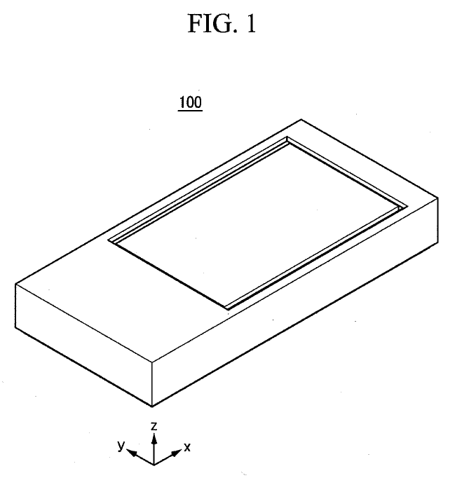

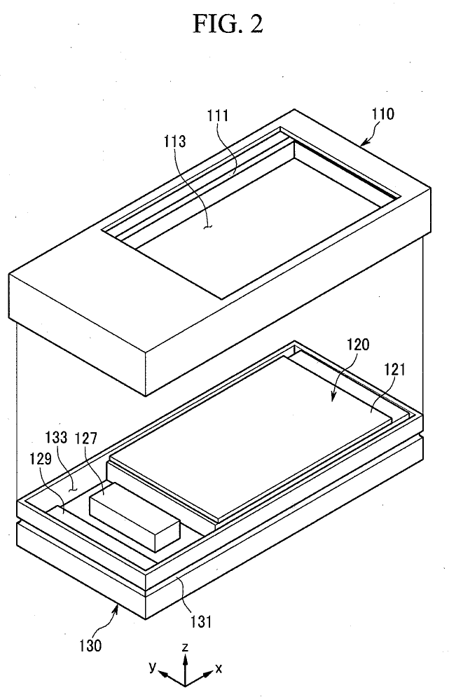

An OLED module of an exemplary embodiment of the present disclosure will be described hereinafter with reference to FIGS. 1 and 2.

FIG. 1 is a perspective view of an OLED module 100 according to an exemplary embodiment of the present disclosure, and FIG. 2 is an exploded perspective view of the OLED module 100 of FIG. 1, when a second frame 110 is separated from a first frame 130.

The OLED module 100 includes an OLED panel 120 in addition to the first and the second frames 130 and 110.

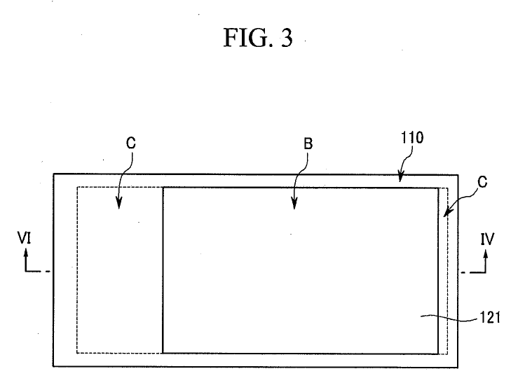

As shown in FIG. 3, light emitting surface (hereinafter, referred to as “front surface”) from which light is emitted in a z-direction in FIGS. 1 and 2 may be divided into a light emitting region B, where an image corresponding to input electrical signals is displayed, and a non-light emitting region C (see FIG. 3).

An optical film 121 for improving an image quality is formed at the light emitting region B. Another aspect is a driving integrated circuit (driving IC) 127 for driving the OLED panel 120 and a flexible printed circuit board (FPCB) for connecting the driving IC 127 to a substrate are installed at the non-light emitting region C.

The non-light emitting region C at which the driving IC 127 and the FPCB 129 are installed may be referred to as “pad region”.

The OLED panel 120 includes a plurality of pixels that are basic elements for displaying the image.

The pixels are arranged in a matrix pattern on the panel. If the OLED panel is an active matrix type, the pixels each include an OLED that displays an image by self-emitting light and a semiconductor device for driving the OLED.

Therefore, the pixels display an image by self-emitting light through the light emitting region B in accordance with external signals.

Various OLED and semiconductor elements may be used. Therefore, the invention is not limited to a particular type of OLED or semiconductor.

The second frame 110 is formed in a rectangular parallelepiped shape having an opened surface facing the OLED panel 120. The second frame 110 includes an opening portion 113 for exposing the light emitting region B of the OLED panel 120 and a convex portion 111 formed along an inner circumference thereof.

The opening portion 113 is formed to correspond to the light emitting region B and has a similar area to the light emitting region B so as not to block the light emitted from the light emitting region.

The convex portion 111 is a protrusion having a semicircular section to function as a part of a coupling structure for coupling the second frame 110 to the first frame 130.

The convex portion 111 may be formed on all inner surfaces (four inner surfaces) or fewer than all surfaces, for example, the convex portion 111 may be formed on only two inner surfaces facing each other.

In this embodiment, the first frame 130 is formed in a rectangular parallelepiped shape having an open surface (top surface in the drawings). The first frame 130 has an inner space 133 for receiving the OLED panel 120, as shown.

The OLED panel 120 is received in the first frame 130 such that it can emit the light toward the open portion of the first frame 130.

In addition, a concave portion 131 that will be engaged with the convex portion 111 of the second frame 110 is formed on an outer surface of the first frame 130.

In some embodiments, the concave portion 131 is a recess having a semicircular section to function as a part of the coupling structure for coupling the second frame 110 to the first frame 130.

The concave portion 131 may, for example, be formed on all outer side surfaces (four outer side surfaces) or two outer side surfaces facing each other as necessary.

Since the convex and concave portions 131 and 111 are engaged with each other, they may be formed to correspond to each other.

Shapes of the first and second frames may vary depending on, for example, a shape of the OLED panel.

In addition, sectional shapes of the convex and concave portions are not limited to the above-described semicircular shape. The sectional shapes of the convex and concave portions may vary as they couple the first and second frames to each other.

For example, the sectional shapes of the concave and convex portions may be a triangular shape, a trapezoidal shape, an oval shape, and/or a hook shape.

The first and second frames 130 and 110 may be formed of stainless steel.

Alternatively, the first and second frames 130 and 110 may be formed of cold rolled steel considering manufacturing cost and strength. Alternatively, the first and second frames 130 and 110 may be formed of aluminum, a nickel-silver alloy, magnesium, a magnesium alloy, or a polymer resin considering weight. The materials of the first frame 130 and the second frame 110 are not limited.

The following will describe an assembly process of the OLED panel 120 and the first and second frames 130 and 110.

The OLED panel 120 is placed in the inner space 133 of the first frame 130 such that the front surface of the OLED 120 faces out of the first frame 130.

Accordingly, the surfaces of the OLED panel 120 other than the front surface are protected by the first frame 130. That is, the side and rear surfaces of the OLED panel 120 can be protected by the first frame 130.

The second frame 110 is subsequently coupled to the first frame 130 such that the opening portion 113 of the second frame 110 corresponds to the light emitting region B of the OLED panel 120.

In this embodiment, because the second frame 110 covers the first frame 130, the side surfaces of the second frame 110 are located on the outer surfaces of the first frame 130. The convex portion 111 of the second frame 110 is engaged with the concave portion 131 of the first frame 130, thereby securely fixing the first and second frames 130 and 110 to each other.

Since the opening portion 113 of the second frame 110 corresponds to substantially only the light emitting region B of the OLED panel 120, the non-light emitting region C of the OLED panel, at which the driving IC 127 is formed, is covered and protected by the second frame 110.

Therefore, because the front surface of the OLED panel 10 is shielded and protected from direct external impact, durability of the OLED module 100 is improved.

In addition, since the first and second frames are securely coupled to each other to define a complete rectangular parallelepiped body, the OLED module 100 is not easily deformed by twisting and bending loads.

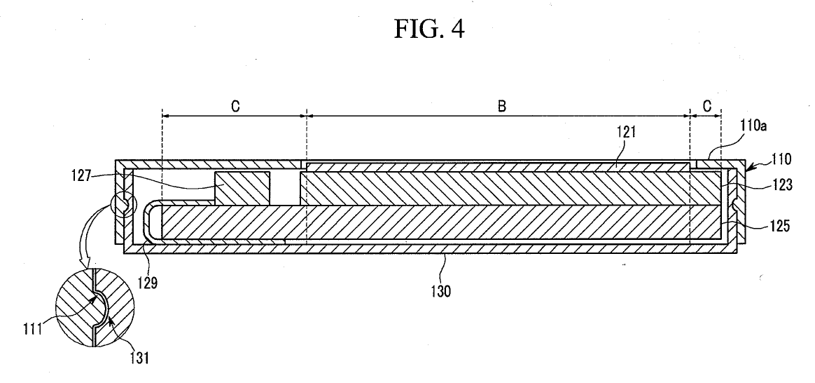

The following will describe the OLED module 100 in more detail with reference to FIGS. 3 and 4.

FIG. 3 is a schematic front view of the OLED module of FIG. 1.

FIG. 4 is a cross-sectional view taken along line IV-IV of FIG. 3.

The enlarged circle of FIG. 4 illustrates a state where the convex portion 111 and the concave portion 131 are engaged with each other.

Referring to FIG. 4, the OLED panel 120 includes a first substrate 125 on which the OLED and semiconductor device are formed, a second substrate 123 that is coupled to the first substrate 125 to protect the OLED and semiconductor device, the driving IC 127 installed at the pad region of the first substrate 125, the FPCB 129 that electrically connects the driving IC 127 to a printed circuit board (not shown), and the optical film 121 formed on only the light emitting region B of the second substrate 123.

As shown in the enlarged circle of FIG. 4, the first and second frames 130 and 110 are coupled to each other by the concave and convex portions 131 and 111 that are engaged with each other.

Therefore, the OLED panel 120 can be more securely protected from an external impact.

The second frame 110 is located on the OLED panel 120 such that the opening portion 113 of the second frame 110 corresponds with the light emitting region B of the OLED panel 120.

That is, the second frame 110 includes a top surface 110a, an inner circumference of which defines the opening portion 113.

In accordance with the second frame 110 structured as described above, the optical film 121 is not needed on the portion of the second substrate 123 where the top surface 110a of the second frame 110 overlaps the second substrate 123.

An adhesive, such as double-sided adhesive tape or an adhesive absorption member may be disposed between the top surface 110a of the second frame 110 and the second substrate 123.

Accordingly, damage to the OLED panel 120 by an external impact can be prevented by the second frame 110 covering the non-light emitting region. As a result, durability of the OLED module 100 is enhanced without increasing the overall thickness of the OLED module 100.

Further, since the second frame 110 contacts and covers the edge of the OLED panel 120, which is vulnerable to electrostatic discharge (ESD), the ESD resistivity of the OLED device is improved.

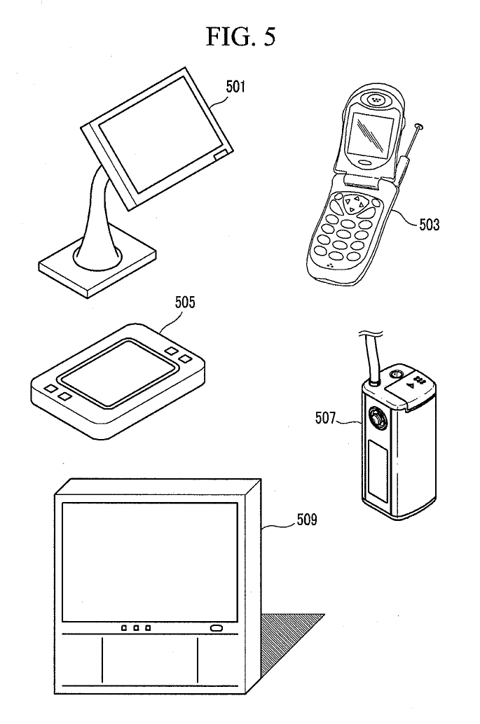

FIG. 5 is a view illustrating a variety of electronic devices to which the OLED display module can be applied.

As shown in FIG. 5, the OLED display may be applied to most types of display devices.

The OLED display may be applied to a computer monitor 501.

Since the OLED display has a quicker response speed than a liquid crystal display, afterimages rarely remain. Thus, the OLED display is more effective for movie and game applications.

Additionally, the OLED display may be applied to a variety of portable electronic devices such as a mobile phone 503, a personal multimedia player 505, an MP3 player 507, and the like.

Since the portable electronic devices are frequently used outside, an OLED display that is effective under sunlight is more appropriate for the portable electronic devices.

There is a good chance that the portable electronic devices will be exposed to external impact. Therefore, when the OLED module is applied to the portable electronic device, the improved durability of the portable electronic device is beneficial.

As the durability of the OLED module is improved, the service life of the OLED display can be improved.

In addition, the OLED display may be applied to a large-sized TV 509.

The OLED display has a higher luminance, a higher contrast, and a quicker response speed than a plasma display panel and a liquid crystal display. Therefore, a clearer image can be obtained by using the OLED display.

While this invention has been described in connection with what is presently considered to be practical exemplary embodiments, it is to be understood that the invention is not limited to the disclosed embodiments, but, on the contrary, is intended to cover various modifications and equivalent arrangements.

What is claimed is:

1. An organic light emitting diode module comprising:
an organic light emitting diode panel comprising a light emitting region and a non-light emitting region;
a first frame comprising an inner space for receiving the organic light emitting diode panel; and
a second frame coupled to the first frame, wherein the second frame is configured to protect the non-light emitting region of the organic light emitting diode panel.

2. The organic light emitting diode module of claim 1, wherein the second frame encloses an outer surface of the first frame.

3. The organic light emitting diode module of claim 2, wherein a coupling structure is formed on the outer surface of the first frame and an inner surface of the second frame, wherein the coupling structure is configured to couple the first frame to the second frame.

4. The organic light emitting diode module of claim 3, wherein the coupling structure comprises concave and convex portions.

5. The organic light emitting diode module of claim 4, wherein the first frame comprises the concave portion and the second frame comprises the convex portion.

6. The organic light emitting diode module of claim 1, wherein the non-light emitting region holds a driving integrated circuit.

7. The organic light emitting diode module of claim 1, further comprising an optical film formed on a light emitting surface of the organic light emitting diode panel in the light emitting region.

8. The organic light emitting diode module of claim 7, wherein the optical film is not provided on the portion of the second substrate where the top surface of the second frame overlaps the second substrate.

9. The organic light emitting diode module of claim 1, wherein the first and second frames are each formed of at least one of stainless steel, cold rolled steel, aluminum, a nickel-silver alloy, magnesium, a magnesium alloy, and a polymer resin.

10. The organic light emitting diode module of claim 1, wherein the first and second frames are shaped to correspond to the shape of the organic light emitting diode panel.

11. The display of claim 1, wherein the second frame comprises an opening corresponding to the light emitting region.

12. An organic light emitting diode display, comprising:
an organic light emitting diode panel comprising a light emitting display and at least one integrated circuit including a driving IC for driving the organic light emitting diode panel;
a first frame configured to receive the organic light emitting diode panel; and
a second frame coupled to the first frame, wherein the second frame is configured to protect the integrated circuit.

13. The display of claim 12, wherein the second frame comprises an opening corresponding to the light emitting display.

14. The display of claim 12, wherein the light emitting display and the integrated circuit are on the same side of the organic light emitting diode panel.

15. The display of claim 12, further comprising an optical film formed on the display.

16. The display of claim 12, wherein the second frame is coupled to the first frame with a convex feature on one of the frames engaged with a concave feature on the other frame.

17. The display of claim 12, wherein the first and second frames are shaped to correspond to the shape of the organic light emitting diode panel.
